(19) United States
(12) Patent Application Publication
(10) Pub. No.: US 2006/0159247 A1
(43) Pub. Date: Jul. 20, 2006

(54) Method for signaling a connection set-up emanating from a calling terminal via a communications network to a called terminal

(75) Inventor: Bernhard Krembs, Gruenwald (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/322,593

(22) Filed: Jan. 3, 2006

Related U.S. Application Data
(63) Continuation of application No. 10/168,702, filed on Jun. 21, 2002, now abandoned.

(30) Foreign Application Priority Data
Dec. 22, 1999 (DE) 19962174.8

(51) Int. Cl. H04M 3/42

(52) U.S. Cl. 379/207.02

(57) ABSTRACT

A method for signaling connection setup emanating from a calling terminal (TLNA) via a communications network to a called terminal (TLNB), where at least one access connection routed to the called terminal is busy, characterized in that, if there is no authorization for such singaling for the relevant called terminal (TLNB), signaling which indicates said connection setup is prompted for the called terminal (TLNB) in the case of the calling terminal (TLNA) or is initiated by the originating exchange (VSTA) in the communications network, in that this originating exchange (VSTA) stores appropriate signaling authorization for the relevant calling terminal (TLNA), and in that the calling terminal (TLNA) or the originating exchange (VSTA) has received a message indicating the busy condition of the at least one access connection routed to the called terminal (TLNB).

### CLAIM FOR PRIORITY

This is a Continuation application of U.S. patent application Ser. No. 10/168,702, filed Jun. 21, 2002, which is a U.S. national stage of PCT/DE00/04402 filed 11 Dec. 2000 which claims priority to German application 19962174.8 filed 22 Dec. 1999.

### TECHNICAL FIELD OF THE INVENTION

The invention relates to a system and method for signaling connection setup emanating from a calling terminal via a communications network to a called terminal.

### BACKGROUND OF THE INVENTION

In today's communications networks, such a method of signaling connection setup is in connection with the service feature “call waiting” or “call offer”. By way of example, the “call waiting” service feature is specified for an ISDN network in an ETSI standard ETS 300 058-1. Use of the “call waiting” service feature allows a called subscriber who is currently on a call with a calling subscriber in the communications network, which means that at least one access connection for his terminal is busy, to have other incoming calls signaled to him. This service feature presupposes that an exchange in the communications network, namely the destination exchange to which the terminal of the called subscriber is normally connected either directly or indirectly via a private branch exchange using a subscriber line, stores authorization for the called subscriber which allows him to use this service feature.

On the basis of the procedure described in the ETSI standard, the “call waiting” service feature involves interchanging the following messages between a calling subscriber and a called subscriber via the communications network:

First, the terminal of the called subscriber receives a “setup message”. This message signifies that there is an incoming call for the terminal. The message is used to provide all the information which the network is able to supply for terminal selection, compatibility checking and, if necessary, for authorization checking (e.g. service features, services). Only if all the access connections routed to the called subscriber's terminal are busy does the called subscriber first need to put a call or data connection into a “hold state” or to terminate said connection. Next, the calling subscriber's terminal is sent an alerting message from the destination exchange via the originating exchange, which notifies the terminal that the called terminal is in principle able to accept the call. When the incoming call has been accepted by the called subscriber, a connect message is used to signal to the calling subscriber that a user connection has been put through in the network.

A drawback of the procedure described is, in particular, that in cases in which no authorization for the “call waiting” service feature is stored for the called subscriber in the exchange, the calling subscriber is not able to signal his connection intent to the called subscriber's terminal while at least one access connection for the called terminal is busy.

### SUMMARY OF THE INVENTION

In one embodiment of the invention, there is a method in which the originating exchange in the communications network initiates signaling, which indicates connection setup in the direction of the called terminal, to the terminal.

One advantage of the invention is, for example, that the signaling of connection setup to the called terminal, where at least one access connection routed to this terminal is busy, no longer depends solely on authorization of the called subscriber. Thus, initiation of the signaling, which indicates setup of the connection, to the called terminal can also be initiated from the calling end, e.g. in the form of the “call waiting” service feature.

In accordance with another embodiment of the invention, the originating exchange's intended initiation of the signaling which indicates setup of the connection can be prompted by the called terminal or can be done on the basis of signaling authorization, stored in the originating exchange, for the calling terminal. Expressed in other words: the calling subscriber can prompt the “call waiting” service feature with the called subscriber explicitly, e.g. by pressing a key on his terminal, or the originating exchange initiates “call waiting” for the called subscriber automatically if signaling authorization is stored for the calling subscriber.

In still another embodiment of the invention, the signaling which indicates setup of the connection is initiated by the originating exchange if it has received a message indicating the busy condition of the at least one access connection routed to the called terminal. Generally, the destination exchange notifies the originating exchange about the busy state of the called terminal. In this embodiment of the invention, the originating exchange thus has control over the initiation of the signaling, which indicates setup of the connection, to the called terminal.

### BRIEF DESCRIPTION OF THE DRAWINGS

Exemplary embodiments of the invention are explained in more detail below with reference to the drawings, in which:

FIG. 1 shows a message sequence when the calling subscriber prompts “call waiting” when received signaling indicates that at least one access connection for the called subscriber's terminal is busy.

FIG. 2 shows a message sequence when the originating exchange initiates “call waiting” automatically on the basis of authorization of the calling subscriber when the originating exchange has been notified that at least one access connection for the called subscriber's terminal is busy.

FIG. 3 shows a message sequence where “call waiting” is signaled to the called subscriber's terminal whenever a connection is set up, provided that at least one access connection for the called subscriber's terminal is busy.

### DETAILED DESCRIPTION OF THE PREFERRED EMBODIMENT

In each of the figures, the message sequence takes place between a terminal TLNA associated with the calling subscriber, an originating exchange, a destination exchange and a terminal TLNB associated with a called subscriber.

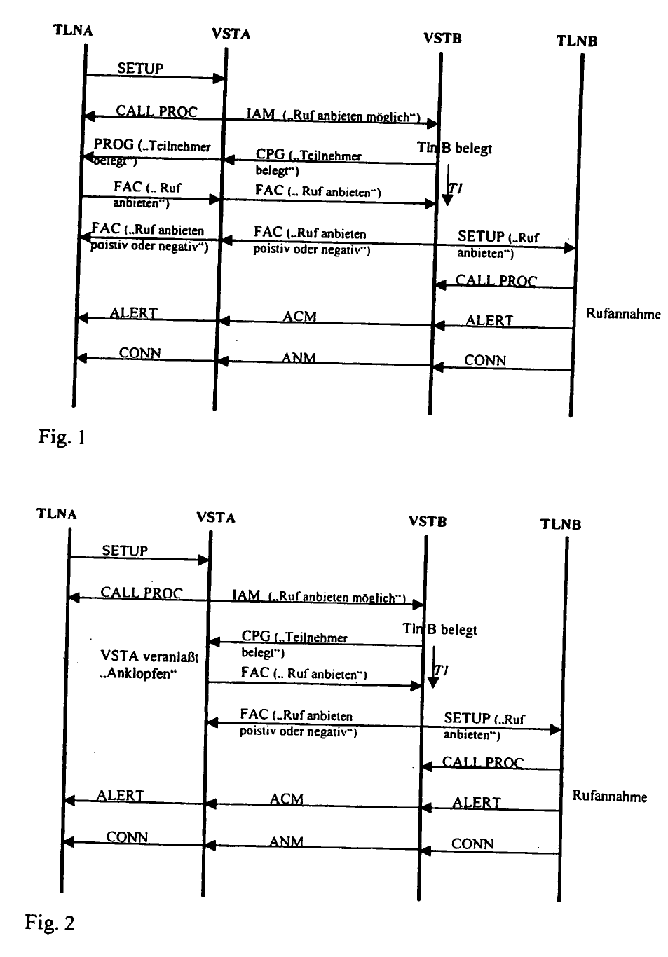

FIG. 1 describes the following exemplary sequence:

The terminal TLNA initiates setup of a connection using the message SETUP, which is received by the originating exchange VSTA. The originating exchange VSTA sends a message CALL PROC back to the terminal TLNA, which signifies that the exchange requires no further dialing information for setting up the connection. In addition, the originating exchange VSTA sends a message IAM (Initial Address Message), including an indicator, e.g. “offer call possible”, to the destination exchange VSTB. What are known as indicators or protocol discriminators are respectively set behind the message names in the figures. Provided that at least one access connection for the terminal TLNB is busy, the destination exchange establishes this and sends the originating exchange VSTA a message CPG (Call Progress Message) which includes an indicator, e.g. “subscriber busy”. The originating exchange VSTA forwards a message PROC including the indicator e.g. “subscriber busy” to the terminal TLNA. When “subscriber busy” has been signaled to the calling subscriber's terminal TLNA, the subscriber has the option of prompting “call waiting”, e.g. by dialing a service number or by pressing a special key. In this case, the terminal TLNA sends the originating exchange VSTA a message FAC (Facility), which includes an indicator, e.g. “offer call”. The originating exchange VSTA forwards the message to the destination exchange VSTB. Between the sending of the message CPG and the arrival of the message FAC in the destination exchange VSTB, a particular time period T1 should not be exceeded, which is checked within the destination exchange VSTB using a timekeeper. The destination exchange VSTB confirms the previously received message FAC using a message FAC containing an indicator, e.g. “offer call possible positive or negative”, to the originating exchange VSTA, which forwards this confirmation to the terminal TLNA. In the case of positive confirmation, the destination exchange VSTB signals a connection setup message SETUP including the indicator e.g. “offer call” to the terminal TLNB. The terminal TLNB returns a message CALL PROC to the destination exchange VSTB. When the incoming call has been signaled using the message SETUP (“offer call”), the called subscriber has the option of accepting the incoming call by putting existing call or data connections into a hold state, or at least initiating a call or data connection. The subscriber can also reject the incoming call indicated by means of the message SETUP (“offer call”).

If the called subscriber has accepted the signaled incoming call, the terminal TLNB sends a message ALERT to the destination exchange VSTB, which notifies the destination exchange VSTB that the terminal TLNB is able to accept the call, and compatibility checks and, if necessary, authorization checks by this terminal have had positive results. The destination exchange VSTB then sends an ACM (Address Complete Message) to the originating exchange VSTA. The originating exchange VSTA sends the terminal TLNA an ALERT message, which signifies that it has been possible to set up a connection to the destination on the network. In addition, the terminal TLNB sends the destination exchange VSTB a message CONN. The destination exchange VSTB forwards a message ANM (Answer Message) to the originating exchange VSTA, which in turn forwards a message CONN to the terminal TLNA. The last message chain provides notification that the incoming call has been accepted by the called terminal TLNB. Automatically answering terminals send a message CONN straight away instead of the message ALERT. The message sequence described in FIG. 2 differs from the sequence described in FIG. 1 for the following reasons:

When the message CPG including the indicator e.g. “subscriber busy” has been sent to the originating exchange VSTA, the originating exchange VSTA checks whether the calling subscriber has authorization to signal “call waiting”. If the subscriber is authorized to do so, the originating exchange VSTA automatically sends the message FAC containing the indicator e.g. “offer call” to the destination exchange VSTB. The destination exchange VSTB confirms this message by returning the message FAC containing the indicator e.g. “offer call positive or negative” to the originating exchange VSTA. Finally, the destination exchange VSTB sends the message SETUP including the indicator e.g. “offer call” to the terminal TLNB. The subsequent message sequence corresponds to the sequence already explained in FIG. 1.

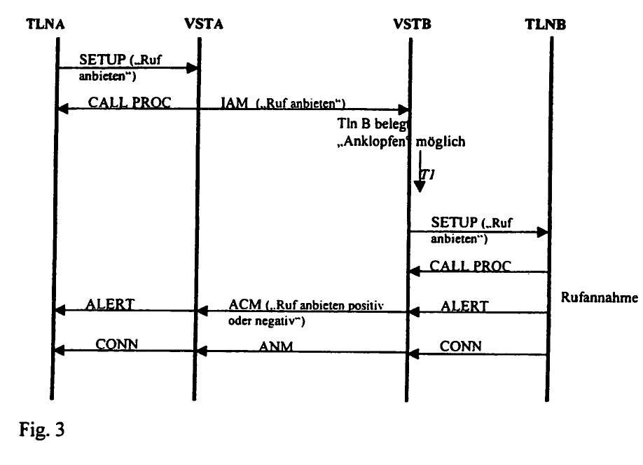

In FIG. 3, the terminal TLNA sends a message SETUP already including the indicator e.g. “offer call” to the originating exchange VSTA. The originating exchange VSTA sends a CALL PROC message back to the terminal and at the same time sends a message IAM including the indicator e.g. “offer call” to the destination exchange VSTB. In this way, “call waiting” is desired by the calling subscriber together with setup of the connection. The destination exchange VSTB establishes whether at least one access connection for the terminal TLNB is busy. If this is the case, the destination exchange VSTB signals a message SETUP including the indicator e.g. “offer call” to the terminal TLNB. The rest of the procedure corresponds essentially to the sequence outlined in FIG. 1 or 2. When the message ACM is sent from the destination exchange to the originating exchange, the message ACM additionally contains a confirmation indicator e.g. “offer call positive or negative”.

If the functions of the originating exchange VSTA and the functions of the destination exchange VSTB are combined in one exchange, the message sequence can be envisaged such that in FIGS. 1 to 3 the message sequence between the exchanges VSTA and VSTB does not take place. Thus, in this case, there would remain a message sequence between a terminal TLNA, a single exchange, e.g. VSTA, and a terminal TLNB.

In addition, the inventive method is in no way limited to communications networks containing ISDN subscriber lines. Instead, corresponding message sequences can also be applied to communications networks including analog subscriber lines or to communications networks which comprise both ISDN and analog subscriber lines.

Also, the terminals associated with a calling and called subscriber can be connected to the originating and destination terminals via a packet-switching communications network, e.g. the Internet.

1. A method for signaling connection setup from a calling terminal via a communications network to a called terminal, where at least one access connection routed to the called terminal is busy, comprising:
prompting signaling, which indicates the connection setup, for the called terminal from the calling terminal or is initiated by the originating exchange in the communications network, when there is no authorization for the signaling for the relevant called terminal; and
storing appropriate signaling authorization for the relevant calling terminal at the originating exchange, wherein
the calling terminal or the originating exchange receives a message, indicating the busy condition of the at least one access connection routed to the called terminal at the calling terminal or the originating exchange.

2-4. (canceled)
